(19) United States
(12) Patent Application Publication
(10) Pub. No.: US 2020/0396429 A1
(43) Pub. Date: Dec. 17, 2020

(54) PROJECTION DEVICE AND PROJECTION SETTING ADJUSTMENT METHOD THEREOF

(71) Applicant: Coretronic Corporation, Hsin-Chu (TW)

(72) Inventor: Tzu-Hai Chung, Hsin-Chu (TW)

(73) Assignee: Coretronic Corporation, Hsin-Chu (TW)

(21) Appl. No.: 16/896,227

(22) Filed: Jun. 9, 2020

(30) Foreign Application Priority Data
Jun. 12, 2019 (CN) 201910504539.3

(51) Int. Cl. H04N 9/31

(52) U.S. Cl. CPC H04N 9/3179

(57) ABSTRACT

Provided is a projection device having a signal receiver, a communication interface, a storage, a processor, and a projection module. The signal receiver receives a signal source. The communication interface is configured to receive context default settings. The storage stores a current setting. The processor is configured to determine a current projection context and receive at least a corresponding one of the context default settings according to the current projection context through the communication interface. The processor adjusts the current setting according to the received context default setting. The projection module is connected to the processor, and projects an image according to the adjusted current setting and the signal source. Further, a projection setting adjustment method for the aforementioned projection device is also provided. The projection device and the projection setting adjustment method thereof of the invention have the effects of facilitating setting and reducing the time required for setting.

### CROSS-REFERENCE TO RELATED APPLICATION

This application claims the priority benefit of China application serial no. 201910504539.3, filed on Jun. 12, 2019. The entirety of the above-mentioned patent application is hereby incorporated by reference herein and made a part of this specification.

### BACKGROUND OF THE INVENTION

### 1. Field of the Invention

The invention relates to a projection device setting technology, in particular, to a projection device and a projection setting adjustment method thereof.

### 2. Description of Related Art

General projectors may often have a default setting at the factory. For example, a manufacturer may set corresponding boot screens and setting parameters one by one according to the orders of different customers before the delivery. When users start the projectors, the default boot screens and the setting parameters can be automatically loaded to project accordingly. After the users start the projectors, projection setting parameters can also be adjusted through setting interfaces of the projectors.

However, for the manufacturer side, each projector needs to be set respectively, which is quite time consuming. In addition, for manufacturers or customers, if a large number of projectors are required to be deployed, each projector must be set and corrected respectively. In addition, after a large number of projectors are deployed, if one of the projectors needs to be eliminated and replaced, the replaced projector must be set according to the deployment requirements.

In addition, for a user, when replacing a personal projector device, even if purchasing a projector with the same brand and similar interface, the user also needs to set the projector device once again and cannot apply the settings of the previous projector device automatically. Not only that, but for portable projectors, only simple options can be set in the applications of different scenarios usually. As a result, it is not easy for a user to set a projector to be applied to all suitable scenarios.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention provides a projector device and a projection setting adjustment method thereof, so as to improve the user convenience for projector setting and shorten the time required for setting.

In order to achieve one, some, or all of the aforementioned objectives or other objectives, an embodiment of the invention provides a projection device. The projection device has a signal receiver, a communication interface, a storage device, a processor, and a projection module. The signal receiver receives a signal source. The communication interface is configured to receive context default settings. The storage device stores a current setting. The processor is connected to the signal receiver, the communication interface and the storage device, and configured to determine a current projection context and receive, according to the current projection context, at least one of the context default settings through the communication interface. The processor adjusts the current setting according to the received context default settings. The projection module is connected to the processor, and projects an image according to the adjusted current setting and the signal source.

In order to achieve one, some, or all of the aforementioned objectives or other objectives, an embodiment of the invention provides a projection device. The projection device has a signal receiver, a communication interface, a storage device, an input device, a processor, and a projection module. The signal receiver receives a signal source. The communication interface is connected to an external device, the external device storing at least the context default settings. The storage device stores a current setting. The input device receives a setting instruction. The processor is connected to the signal receiver, the communication interface, the storage device, and the input device, and the processor receives one of the at least one context default setting through the communication interface and adjusts the current setting according to the received context default setting. The processor further adjusts the current setting according to the setting instruction and stores the adjusted current setting to the external device as the context default setting. The projection module is connected to the processor, and projects an image according to the adjusted current setting and the signal source.

In order to achieve one, some, or all of the aforementioned objectives or other objectives, an embodiment of the invention provides a projection setting adjustment method that is applied to a projection device connected to an external device. The projection setting adjustment method includes the following steps: receiving a signal source; determining a current projection context; acquiring a corresponding context default setting from the external device according to the current projection context; adjusting a current setting according to the context default setting; and projecting an image according to the current setting and the signal source.

In order to achieve one, some, or all of the aforementioned objectives or other objectives, an embodiment of the invention provides a projection setting adjustment method that is applied to a projection device connected to an external device. The projection setting adjustment method includes the following steps: receiving a signal source; receiving a setting instruction; acquiring a context default setting from the external device; adjusting a current setting according to the context default setting and the setting instruction, and storing the adjusted current setting to the external device as the context default setting; and projecting an image according to the current setting and the signal source.

Based on the above, the projection device and the projection setting adjustment method of the invention can determine a current projection context through a processor, and acquire a context default setting through a communication interface. A user does not need to set projection devices one by one, thereby improving the setting convenience of projection devices, and effectively shortening the setting time.

Other objectives, features and advantages of the invention will be further understood from the further technological features disclosed by the embodiments of the invention wherein there are shown and described preferred embodiments of this invention, simply by way of illustration of modes best suited to carry out the invention.

In order to make the aforementioned and other objectives and advantages of the invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic device diagram of a projection device according to an embodiment of the invention.

FIG. 2 illustrates a schematic flowchart of a projection setting adjustment method according to an embodiment of the invention.

FIG. 3 illustrates a schematic device diagram of a projection device according to another embodiment of the invention.

FIG. 4 illustrates a schematic flowchart of a projection setting adjustment method according to another embodiment of the invention.

### DESCRIPTION OF THE EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

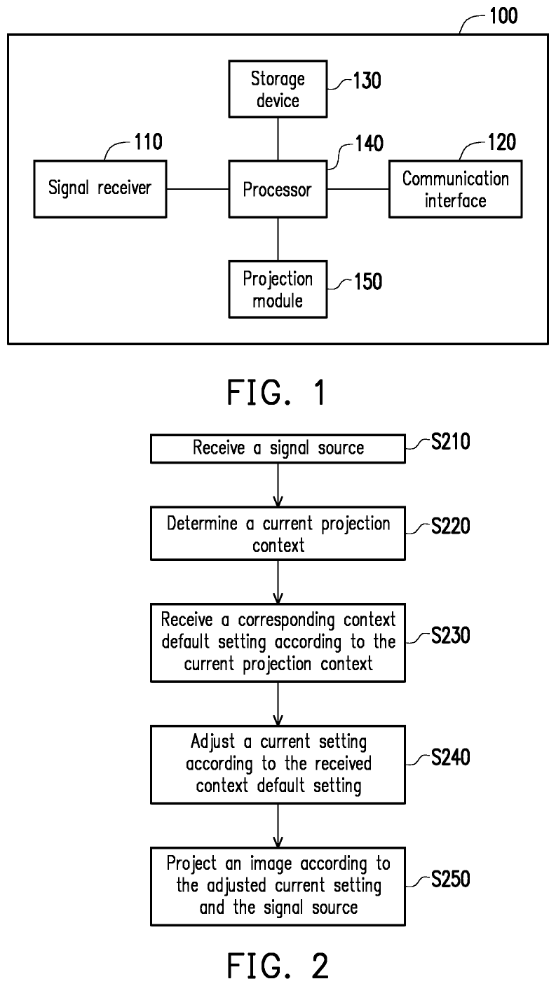

FIG. 1 illustrates a schematic device diagram of a projection device according to an embodiment of the invention. Referring to FIG. 1, the projection device 100 has a signal receiver 110, a communication interface 120, a storage device 130, a processor 140, and a projection module 150.

The signal receiver 110 is configured to receive a signal source (projection content), for example, a display data channel command interface (DDC/CI), a wireless fidelity (Wi-Fi), a high definition multimedia interface (HDMI), a digital visual interface (DVI), an S terminal, an AV terminal, a video graphics array connector (VGA) terminal, etc. Still alternatively, the signal receiver 110 may be a combination of the plurality of aforementioned interfaces, and the invention is not limited thereto.

The communication interface 120 is configured to receive at least one context default setting. Specifically, the communication interface 120 can be connected to an external device by wire or wirelessly. For example, the communication interface 120 is, for example but not limited to, a Wi-Fi-enabled communication chip, a Bluetooth-connected communication chip, an RS-232 interface, a universal serial bus (USB) interface, an RJ45 interface, or a combination of various types of interfaces described above. The external device is, for example but not limited to, an external hard disk drive, an external storage, a remote server, a cloud storage space, or a combination of various types of external devices described above. The context default setting is a parameter setting value of the projection device corresponding to various different contexts. Various types of contexts are, for example, different usage modes (e.g., theater, conference, game, eye protection, high dynamic range imaging, or standard), different setting contexts (e.g., mass layout, factory settings, or spliced projection layout), and different usage environments (e.g., different brightness, indoor, outdoor, space size, number of viewers, or projection plane characteristics), but the invention is not limited thereto. The parameter setting values are, for example, a default boot screen, an operation interface theme color, a waiting signal screen or other settings relating to the device itself, or settings relating to an environment or a projecting situation such as brightness, contrast, saturation, and color compensation, or a combination of various types of setting values described above. For example, in an embodiment of the invention, the context is “standard” with a resolution of 1080P. In another embodiment of the invention, the context is “exhibition spliced projection setting”, the default boot screen is an exhibition logo, the brightness setting value corresponds to a 90^{th} order in 100-order brightness supported by the projection device, the resolution is 1080P, and the segmentation position is a sub-screen at a 3×1 location in a 3×3 segmentation setting. In still another embodiment of the invention, the context is a “low-brightness environment setting”, the brightness setting value corresponds to a 30^{th} order in 100-order brightness supported by the projection device, and the color saturation is 60%. In still another embodiment of the invention, the context is “theater”, the color saturation is 100%, the resolution is 1080P, and the sound output is multi-channel output. Since the parameters to be adjusted in each context are not the same, context default settings in different contexts may correspond to the same or different setting values, and the invention is not limited thereto.

The storage device 130 is configured to store data and program codes required by the projection device 100. In particular, the storage device 130 stores a current setting of the projection device 100. The current setting is various setting values adopted when the current projection device 100 projects an image, for example, a default boot screen or other settings relating to the device itself, or settings relating to an environment or a projecting situation such as brightness and saturation, or a combination of various types of setting values described above. In the embodiments of the invention, a setting value of the context default setting corresponds to one, some or all of the setting values in the current setting. In the embodiments of the invention, the storage device 130 may be implemented by various types of non-volatile memories, such as a hard disk drive (HDD), a solid-state drive (SSD), and other storage devices, but the invention is not limited thereto.

The processor 140 is connected to the signal receiver 110, the communication interface 120 and the storage device 130, and configured to perform various types of operations required by the projection device 100. In particular, the processor 140 may determine a current projection context, receive, according to the current projection context, the corresponding one of at least one context default setting through the communication interface, and adjust the current setting according to the received context default setting. The process of the processor 140 performing the operations will be described later. In an embodiment of the invention, the processor 140 is, for example, a central processing unit (CPU), a microprocessor, a digital signal processor (DSP), a programmable controller, a programmable logic device (PLD), other similar devices, or a combination of these devices, and the invention is not limited thereto.

The projection module 150 is connected to the processor 140 and configured to project an image to a projection plane according to the current projection context and the signal source. The projection module 150 is, for example, a device including a digital micromirror device (DMD) or a liquid-crystal-on-silicon (LCOS) panel, but the invention is not limited thereto.

FIG. 2 illustrates a schematic flowchart of a projection setting adjustment method according to an embodiment of the invention. The projection setting adjustment method of the embodiment is at least applicable to the projection device 100 of the embodiment of FIG. 1. Therefore, the details of the operation of the projection device 100 and the projection setting adjustment method will be described below with reference to FIG. 1 and FIG. 2 at the same time.

The projection device operation and projection setting adjustment method includes the following steps. In step S210, the signal receiver 110 receives a signal source.

In step S220, the processor 140 determines a current projection context. In an embodiment of the invention, the processor 140 analyzes the content of the signal source to determine a current projection context according to the content of the signal source. Specifically, the processor 140 may analyze at least one of a frame rate, an image average brightness, an image contrast, a high dynamic range imaging situation, an in-image object moving speed, and an image resolution from the signal source, so as to determine a current projection context. For example, if the frame rate of the signal source is high or the in-image object moving speed is high, the processor 140 determines that the current projection context is “game” accordingly. When the image average brightness is high, the processor 140 may determine that the current projection context is “eye protection”. Alternatively, when it is detected that the image brightness difference is large or the image contrast is high, the processor 140 may determine that the current projection context is “high dynamic range imaging (HDR)”.

In another embodiment of the invention, the projection device 100 is further provided with an external environment detector (not shown) connected to the processor 140, for example, an external light sensor, a camera, a gyroscope, etc., configured to detect an external environment and generate corresponding environmental information. Thereby, the processor 140 may determine the current projection context according to the environmental information. For example, the external light sensor can sense a current ambient light to generate environmental information of the corresponding ambient light. The processor 140 may determine that the current projection context is “high brightness” when the current ambient light is high. The camera can capture the external environment, thereby generating corresponding environmental information such as brightness, number of people, and environmental space. For example, when the number of people is large and the light is bright, the processor 140 may determine that the current projection context is “conference”. Alternatively, when a person captures, by the camera, an external environment where many people walk around, the processor 140 may determine that the current projection context is “exhibition”. Alternatively, when the environment space for capturing through the camera is small, it is determined that the current projection context is “small space”, etc.

The projection device 100 may also determine the current projection context according to the environmental information and the content of the signal source. For example, when the in-image object moving speed is high and the current ambient light is high, the processor 140 may determine that the current projection context is “game and high brightness”. The invention does not limit a specific manner in which the projection device 100 determines the current projection context.

It is worth mentioning that there are many parameters that can be adjusted in the projection device 100, and the current projection context can correspond to more fine adjustments. Therefore, the current projection context is not necessarily the same as a projection mode selectable for a user in a setting interface.

In step S230, the processor 140 acquires a corresponding context default setting according to the current projection context. In an embodiment of the invention, the processor 140 may store the context default setting in the storage device 130. Alternatively, the processor 140 may also be connected to an external device (such as a remote server and an external hard disk drive) through the communication interface 120, and may acquire a corresponding context default setting in at least one context default setting from the external device.

In step S240, the processor 140 adjusts a current setting according to the received context default setting. A setting value of the context default setting corresponds to one, more or all of the setting values in the current setting. Therefore, the processor 140 may adjust the corresponding setting value in the current setting according to the setting value of the context default setting. For the setting value not included in the context default setting, the processor 140 does not adjust an original setting.

In step S250, the processor 140 projects an image according to the adjusted current setting and the signal source.

It is worth mentioning that in the embodiments of the invention, for different projection devices 100, the current settings output by the processor 140 as the context default settings are all in a specific formats (standard format, for example), for example, a text file stored in a text file (.txt) or a comma-separated values (CSV) file. Alternatively, the current settings are written in a fixed field in a database by using an SQL syntax. And, a title name of each corresponding field is set to be consistent. For example, but not limited to, the field corresponding to the brightness value of each projection device is set to “B_value”. Thereby, current setting contents transmitted to the external device are all the same, the external device can read current settings uploaded by the projection devices 100 according to the format, and the projection devices 100 can read the current setting contents uploaded by each other. Based on this, if a user replaces or uses another projection device, it is also easy to import an originally adjusted projecting setting.

In some embodiments of the invention, the external device may also have a parsing function. Specifically, when receiving a current setting (non-standard format) transmitted by the projection device 100, the external device can automatically convert the current setting transmitted by the projection device 100 into a specific format, for example, a text file stored in a text file (.txt) or a comma-separated values (CSV) file. Alternatively, the current setting are written in a fixed field in a database by using an SQL syntax. Thereby, the external device can organize all current projection contexts into a consistent storage format. In addition, in some embodiments, the external device can also discriminate the model of the projection device 100 and an instruction format applicable thereto, so as to enable the projection device 100 to convert, when reading the context default setting, the context default setting into the instruction format applicable to the projection device 100. Thereby, for the projection devices 100 of different brands, even if an export current setting and an import context default setting adopt different formats, the projection devices 100 of different brands is enabled to read the current settings uploaded by each other as the context default settings by means of the adjustment of the external device. The invention is not limited thereto. In other embodiments of the invention, the parsing function for the current settings may be provided on the projection device 100. That is, the projection device 100 may receive current setting formats in different formats, and convert current settings in different formats into a specific format by means of the parsing function provided on the projection device 100, so as to adjust a context setting value of the projection device 100.

It is worth mentioning that in an embodiment of the invention, when uploading the current setting, the projection device 100 also uploads its own device information, for example, a device serial number or a device model. Thereby, the external device stores the adjusted current setting as a context default setting exclusive to the device information in the current projection context. That is to say, the external device can not only store and update preset context default settings, but also store context default settings exclusive to a specific projection device 100. Based on this, if a user replaces or uses another projection device, it is also easy to use original device setting to adjust as an originally adjusted projecting setting.

In addition, in some embodiments of the invention, the processor 140 further transmits device request information to the external device through the communication interface 120, such that the external device returns a device default setting corresponding to the device request information. The device default setting has a plurality of setting values, and the setting values of the device default setting correspond to one or more setting values in the current setting. In detail, the device request information has at least device information and a download request. The device information is, for example, a device serial number or device model of the projection device 100, and the download request is, for example, a request for requesting to download the device default setting. Thereby, the external device may search for various types of default settings of its storage device to find the device default setting corresponding to the device serial number. The processor 140 adjusts the current setting according to the device default setting when receiving the device default setting through the communication interface 120. The invention is not limited thereto. In other embodiments of the invention, the processor 140 may automatically scan whether there is a device default setting corresponding to device information in the external device when detecting a connection signal from the external device, and adjust the current setting according to the device default setting if there is the device default setting corresponding to the device information.

In an application context, the factory does not need to provide additional customized settings for the projection device 100 when the projection device 100 is to be delivered from the factory. When the projection device 100 is enabled (start the projection device, for example) and connected to the external device through the communication interface 120, device request information is automatically transmitted to the external device. The external device may determine according to device information (device serial number or device model of the projection device, for example). For example, the external device determines that the device information is a machine customized by a manufacturer A. Therefore, the external device returns a device default setting as “factory setting of manufacturer A”, a corresponding parameter setting value is, for example, that a default boot screen is a brand logo of the manufacturer A, and a brightness setting value corresponds to a 50^{th} order in 100-order brightness supported by the projection device. Thereby, the projection device 100 initializes each setting value according to the device default setting after receiving the device default setting. Similarly, in the case of layout of a large number of projection devices, layout personnel are not required to set the projection devices 100 one by one. When the projection device 100 is connected to the external device through the communication interface 120, device request information is automatically transmitted to the external device. The external device may determine according to device information. For example, the external device determines that the device information is a machine of an exhibition B, and thus returns a device default setting as “exhibition B setting”. The projection device 100 may automatically adjust the setting value after receiving the device default setting. Based on this, the time for setting the projection device 100 by factory personnel and layout personnel is shortened. It should be noted that considering the necessity of different users for device default settings, in some embodiments, the projection device 100 may set an additional setting option to turn on or off automatic downloading of the device default settings. The invention is not limited thereto.

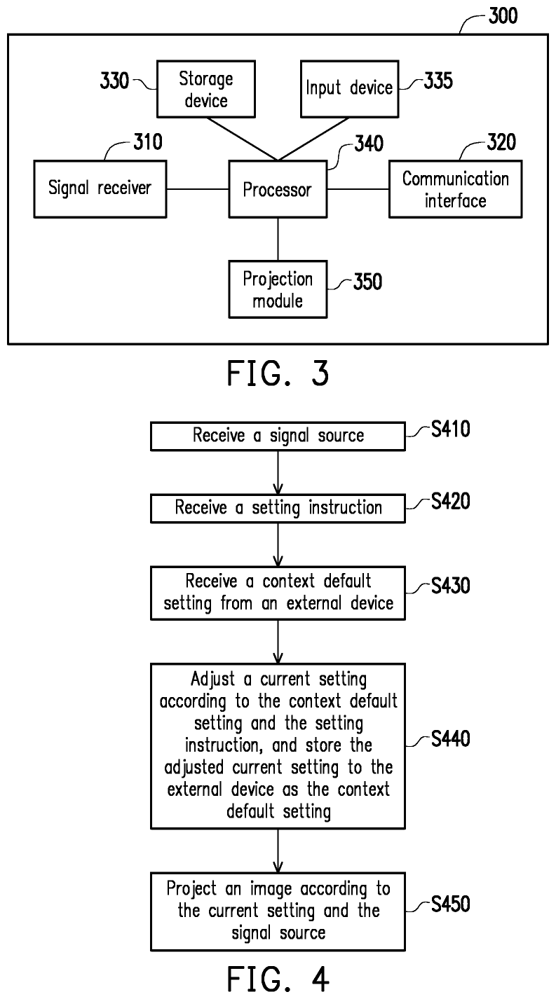

FIG. 3 illustrates a schematic device diagram of a projection device according to another embodiment of the invention. Referring to FIG. 3, the projection device 300 has a signal receiver 310, a communication interface 320, a storage device 330, an input device 335, a processor 340, and a projection module 350. The signal receiver 310, the communication interface 320, the storage device 330, the processor 340, and the projection module 350 are similar to the signal receiver 110, the communication interface 120, the storage device 130, the processor 140, and the projection module 150 of the embodiment of FIG. 1. The descriptions thereof are omitted herein.

Different from the embodiment of FIG. 1, the projection device 300 also has the input device 335. The input device 335 is connected to the processor 340, and configured to allow a user to input an instruction into the projection device 300. For example, the input device 335 is, for example, a keypad disposed on a housing of the projection device 300, and may also be a remote controller communicatively connected to the processor 340, or the input device 335 may also be implemented as an electronic device (e.g., a mobile phone or/and applications therein) of a user (for example, the electronic device of the user is communicatively connected to the processor 335, and the electronic device is enabled to complete an instruction input function). The invention does not limit the implementation of the input device 335.

In an embodiment of the invention, the input device 335 is configured to receive a setting instruction. The setting instruction is, for example, a context setting instruction, an individual context setting instruction, and an individual setting instruction. The context setting instruction allows a user to input a specific context, such as “game” or “eye protection”. The individual context setting instruction allows a user to input a customized context, for example, corresponding to a “personal game” mode. The individual setting instruction allows a user to adjust one or more setting values in a current setting.

In the embodiment, according to a similar schematic flowchart of a projection setting adjustment method of the embodiment of FIG. 2, the projection device 300 may first determine a current projection context. After adjusting a current setting in step S240, the step of receiving a setting instruction input by a user via the input device 335 is first performed. Thereby, the projection device 300 may automatically adjust according to an environmental situation and the content of a played video. The user may further input a setting instruction (for example, increasing the 10-order brightness, increasing the 30-order contrast, changing the boot screen, etc.) through the input device 335, such that the processor 340 adjusts the current setting according to the setting instruction, finely adjusts the setting value to a projection effect that is preferred by the user, step S250 is then performed, and the processor 340 projects an image according to the adjusted current setting and the signal source. In particular, the processor 340 may have different implementations. For example, the processor 340 is configured to determine the current projection context to adjust the current setting, the processor 340 is configured to determine the current projection context and adjust the current setting according to the setting instruction, or the processor 340 only adjusts the current setting according to the setting instruction. The invention does not particularly limit the implementation of the processor 340.

It is worth mentioning that in an embodiment of the invention, the processor 340 may also store the adjusted current setting to the external device as the context default setting in the current projection context. For example, if the current projection context is “game”, and the setting instruction received by the processor 340 is 10-order brightness increase and 15-order contrast decrease, the brightness becomes the 60th order of 100, and the contrast ratio is −15%. At this time, the processor 340 may return the current setting to the external device, such that the external device stores the adjusted current setting as the context default setting in the current projection context until a projection context setting “game”. That is, the projection context setting “game” adjusted by the user, is acquired from the external device next time.

FIG. 4 is a schematic flowchart of a projection setting adjustment method according to another embodiment of the invention. The projection setting adjustment method of the embodiment is at least applicable to the projection device 300 of the embodiment of FIG. 3. Therefore, the details of the operation of the projection device 300 and the details of the projection setting adjustment method will be described below with reference to FIG. 3 and FIG. 4 at the same time.

In step S410, the signal receiver 310 receives a signal source.

In step S420, the input device 335 receives a setting instruction. Different from the embodiment of FIG. 2, in the embodiment, the setting instruction is input directly by the user through the input device 335. As described above, the setting instruction is, for example, a context setting instruction and an individual context setting instruction. The context setting instruction allows a user to input a specific context, such as “game” or “eye protection”. The individual context setting instruction allows a user to input a customized context, for example, corresponding to a “personal game” mode.

In step S430, a context default setting is acquired from the external device through the communication interface 320. In step S440, the processor 340 adjusts the current setting according to the context default setting and the setting instruction, and stores the adjusted current setting to the external device as the context default setting. In step S450, the projection module 350 projects an image according to the current setting and the signal source. Steps S430 to S450 are similar to steps S230 to S250 of the embodiment of FIG. 2, and the descriptions thereof are omitted herein.

In addition, the projection device 300 may also allow a user to input a setting instruction belonging to an individual setting instruction. That is, the user can adjust one or more setting values in a current setting to finely adjust the current setting. In addition, the projection device 300 can also transmit the current setting adjusted by the user to the external device, and then the current setting is used as the context default setting in the current projection context. Moreover, the projection device 300 can also transmit the device information and the current setting together to the external device, such that the current setting is used as the context default setting of the device information in the current projection context. The projection device 300 can also transmit device request information to the external device through the communication interface 320, such that the external device returns a device default setting corresponding to the device request information. The details are similar to the embodiment of FIG. 1 and FIG. 2, and the descriptions thereof are omitted herein.

Based on the foregoing, the projection device and the projection setting adjustment method of the invention can determine a current projection context through a processor, and acquire a context default setting through a communication interface. A user does not need to set projection devices one by one, thereby effectively shortening the setting time. Moreover, the projection device can also upload the setting adjusted by the user to the external device to update the context default setting. In addition, the context default setting can also be shared between different projection devices by coordinating different projection devices by the external device. Furthermore, the projection device may also upload its own device information and context default settings to the external device. Based on this, if a user replaces or uses another projection device, it is also easy to input original device information to set as an originally adjusted playing setting. Portable projectors may also be set by downloading corresponding context default settings.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A projection device, comprising a signal receiver, a communication interface, a storage device, a processor, and a projection module, wherein
the signal receiver receives a signal source;
the communication interface is configured to receive at least one context default setting;
the storage device stores a current setting;
the processor is connected to the signal receiver, the communication interface and the storage device, and configured to determine a current projection context and receive a corresponding one of the at least one context default setting according to the current projection context through the communication interface, the processor adjusting the current setting according to the received context default setting; and
the projection module is connected to the processor, and projects an image according to the adjusted current setting and the signal source.

2. The projection device according to claim 1, wherein the processor analyzes the content of the signal source, and determines the current projection context according to the content of the signal source.

3. The projection device according to claim 1, further comprising:
an external environment detector, connected to the processor, and configured to detect an external environment and generate environmental information, such that the processor determines the current projection context according to the environmental information.

4. The projection device according to claim 1, wherein the communication interface is configured to connect to an external device, the external device storing the at least one context default setting.

5. The projection device according to claim 4, further comprising:
an input device, connected to the processor and configured to receive a setting instruction, wherein the processor adjusts the current setting according to the setting instruction, and stores the adjusted current setting to the external device as the context default setting in the current projection context.

6. The projection device according to claim 4, wherein the processor further transmits device information to the external device through the communication interface, such that the external device stores the adjusted current setting as the context default setting of the device information in the current projection context.

7. The projection device according to claim 4, wherein the processor further transmits a device request information to the external device through the communication interface, such that the external device returns a device default setting corresponding to the device request information, and
the processor adjusts the current setting according to the device default setting in response to that receiving the device default setting through the communication interface.

8. The projection device according to claim 4, wherein the processor further automatically scans whether there is a device default setting corresponding to device information in the external device in response to that detecting a connection signal from the external device, and adjusts the current setting according to the device default setting if there is the device default setting corresponding to the device information.

9. A projection device, comprising a signal receiver, a communication interface, a storage device, an input device, a processor, and a projection module, wherein
the signal receiver receives a signal source;
the communication interface is configured to connect to an external device, the external device storing at least one context default setting;
the storage device stores a current setting;
the input device receives a setting instruction;
the processor is connected to the signal receiver, the communication interface, the storage device, and the input device, and the processor receives one of the at least one context default setting through the communication interface and adjusts the current setting according to the received context default setting, the processor further adjusting the current setting according to the setting instruction and storing the adjusted current setting to the external device as the context default setting; and
the projection module is connected to the processor, and projects an image according to the adjusted current setting and the signal source.

10. A projection setting adjustment method for a projection device, the projection device being connected to an external device, the method comprising:
receiving a signal source;
determining a current projection context;
acquiring a corresponding context default setting from the external device according to the current projection context;
adjusting a current setting according to the context default setting; and
projecting an image according to the current setting and the signal source.

11. The projection setting adjustment method according to claim 10, wherein the step of determining the current projection context further comprises:
analyzing the content of the signal source to determine the current projection context according to the content of the signal source.

12. The projection setting adjustment method according to claim 10, wherein the step of determining the current projection context further comprises:
detecting an external environment and generating environmental information to determine the current projection context according to the environmental information.

13. The projection setting adjustment method according to claim 10, further comprising:
receiving a setting instruction;
adjusting the current setting according to the setting instruction; and
storing the adjusted current setting to the external device as the context default setting in the current projection context.

14. The projection setting adjustment method according to claim 10, further comprising:
transmitting device information to the external device, such that the external device stores the adjusted current setting as the context default setting of the device information in the current projection context.

15. The projection setting adjustment method according to claim 10, further comprising:
transmitting device request information to the external device, such that the external device returns a device default setting corresponding to the device request information; and
adjusting the current setting according to the device default setting.

16. The projection setting adjustment method according to claim 10, further comprising:
scanning whether there is a device default setting corresponding to device information in the external device, and adjusting the current setting according to the device default setting if there is the device default setting corresponding to the device information.

17. A projection setting adjustment method for a projection device, the projection device being connected to an external device, the method comprising:
receiving a signal source;
receiving a setting instruction;
acquiring a context default setting from the external device;
adjusting a current setting according to the context default setting and the setting instruction, and storing the adjusted current setting to the external device as the context default setting; and
projecting an image according to the current setting and the signal source.
